(19) United States
(12) Patent Application Publication
(10) Pub. No.: US 2009/0164298 A1
(43) Pub. Date: Jun. 25, 2009

(54) System and Method for Market Reserve Price Modeling in Online Auctions with Advanced Match

(75) Inventors: Ilya Gluhovsky, Daly City, CA (US); Chi-Chao Chang, Santa Clara, CA (US)

Correspondence Address: BAKER BOTTS L.L.P., 2001 ROSS AVENUE, 6TH FLOOR, DALLAS, TX, 75201, US

(73) Assignee: Yahoo!, Sunnyvale, CA (US)

(21) Appl. No.: 11/962,582

(22) Filed: Dec. 21, 2007

(51) Int. Cl. G06Q 30/00

(52) U.S. Cl. 705/10; 705/14

(57) ABSTRACT

Apparatuses, methods, and systems directed to the estimation and modeling of market reserve prices for bidded terms in online keyword auctions with advanced match. Some embodiments of the invention estimate advertiser value distributions and advertiser bid distributions for the bidded terms and derive expected overall revenue. An optimization technique may be used to find the optimal market reserve prices for the bidded terms that maximize the expected overall revenue. In some other embodiments, a query is received for which a market reserve price is determined and exact and advanced matched advertisements are reordered for output and display.

### TECHNICAL FIELD

The present disclosure relates to modeling and demand estimation for determination of market reserve prices in online keyword auctions.

### BACKGROUND

Internet search engines widely use online keyword auctions to sell advertising spaces on search results pages. In a typical online keyword auction, participating advertisers bid on certain terms for their advertisements. Each term comprises one or more keywords. When a query submitted to an Internet search engine partially or completely matches a bidded term, the advertisements from participating advertisers may be listed along with the search results of the query. If the whole query exactly matches the bidded term, an “exact match” occurs, and the advertisement bidded on the exact matched term may be displayed. If the query is determined to be related to a bidded term but does not completely match the bidded term, an “advanced match” occurs, and the advertisements for the bidded term may also be displayed. For example, an advertiser bids on a term “tennis racquet” for an advertisement of a Wilson™ tennis racquet. If a user enters a query “tennis racquet”, an exact match occurs and the Wilson™ tennis racquet advertisement may be displayed along with the search results of the query. On the other hand, if a user enters a query “wilson racquet” which does not exactly match the bidded term “tennis racquet”, an advanced match may occur and the Wilson™ tennis racquet advertisement may nevertheless be displayed.

The exact and advanced matched advertisements are usually displayed in certain advertising spaces on a Web page. When the Web page is a search results page of a query, the advertising spaces are typically on the top, bottom, left, or right hand side of the search results page. The advertisements are usually ordered by the amount of the bid and the relevance of the advertisement to the query. The advertisers are only charged when the advertisement is clicked on, presumably by a human being. This type of advertising service provided by the Internet search engines is often referred to as Pay-Per-Click (PPC) advertising, which is different from the traditional impression based accounting for advertisements. Traditionally, advertisers are charged by the number of impressions an advertisement is shown to a target audience. PPC advertising gives more visibility to advertisers as to who may be interested in the advertisements and who may ultimately enter a transaction to purchase the advertised products or services. Therefore, PPC advertisers are willing to bid on certain keywords in an online auction to more precisely target advertising audiences. As a result, online keyword auctions have generated significant revenue for the Internet search engines.

The number of online keyword auctions conducted on a daily basis at the major Internet search engines is on the order of hundreds of millions. The revenue generated by the auctions may reach tens of billions of dollars per year for the Internet search engines. Consequently, the online keyword auction has attracted considerable attention from practitioners as well as academics. One research area involves designing an optimal auction mechanism and finding optimal market reserve prices for the keywords in an online auction. There are many different kinds of auctions. In an English auction, bids increase and the highest bidder wins and pays the bid as price. In a Dutch auction, the first bidder to stop the descending bids wins and pays the bid as price. In a second price auction, the highest bidder wins, but pays the second highest bid as price. Myerson, R., Optimal Auction Design, Mathematics of Operation Research 6, 58-73 (1981), proves that adding a market reserve price to an otherwise efficient auction is an optimal mechanism in a single-unit auction in the case of symmetric bidders. A market reserve price is a minimum bid; there is no sale if the bids are below the market reserve price. In general, however, the auction for search advertisements is a multi-unit auction, wherein each unit may be a position of an advertisement on a search results page, and optimal mechanism design in multi-unit auctions has received significant attention. Edelman, Z., and Schwarz M, Optimal Auction Design in a Multi-unit Environment: The Case of Sponsored Search Auctions, in ACM Conference on Electronic Commerce, 2007, shows that Generalized Second Price (GSP) auction with a reserve price is an optimal mechanism in multi-unit auctions. In a GSP auction, if all bidders have the same quality and other attributes, the n^{th} highest bidder pays the bid of the (n+1)^{th} bidder. If bidders have different attributes, the bid may be adjusted based on the difference. They also show how to calculate the optimal reserve price.

### SUMMARY

The present invention provides apparatuses, methods, and systems directed to determining optimal market reserve prices for one or more bidded terms in online keyword auctions with advanced match. The theoretical analyses of market reserve prices in multi-unit online auctions have neglected the role and importance of advanced matched advertisements. In general, all major Internet search engines offer advanced match as an option. Once an advertiser opts in to advanced match, advertisements may be displayed for a query that is different from the bidded terms. In a multi-unit online auction with advanced match, it appears that the role of optimal reserve prices has not been investigated. The Internet search engines may reasonably wonder what market reserve prices may maximize overall expected revenue from online keyword auctions with advanced match. In these and other contexts, a key factor to optimize the market reserve prices for an online auctioneer to maximize revenue in a multi-unit online auction is to take advanced match into consideration in the modeling and optimization process. Accordingly, some embodiments of the invention infer advertiser value distributions for the bidded terms from previous bids. Advertiser bid distributions may be derived from the advertiser value distributions. Expected revenue may be computed for each bidded term from the advertiser bid distribution. Overall revenue may be estimated based on the expected revenue and the popularity of the bidded terms. An optimization technique may be used to find optimal market reserve prices for the bidded terms that maximize overall expected revenue.

In one embodiment of the present invention, the apparatuses and methods are directed to an optimization process that determines optimal market reserve prices for any user defined subset of the bidded terms while the market reserve prices are fixed for the rest of the bidded terms.

In other embodiments of the present invention, the apparatuses, methods, and systems involve receiving a bidded term from an advertiser participating in an online auction, determining a market reserve price for the term, and outputting the market reserve price for display.

In other embodiments of the present invention, the apparatuses, methods, and systems involve receiving a query from an Internet search engine user, finding exact and advanced matched advertisements for the query, determining a market reserve price, excluding advertisements for which the bids are below the market reserve price, and reordering the remaining advertisement for output and display along with the search results of the query.

The following detailed description together with the accompanying drawings will provide a better understanding of the nature and advantages of various embodiments of the present invention.

### DESCRIPTION OF THE DRAWINGS

FIG. 1 is a diagram showing an example communication network, which network may be used with an embodiment of the present invention.

FIG. 2 is a diagram showing an example system architecture for a client system or a server, which may be used by an embodiment of the present invention.

FIG. 3 is a diagram showing a flowchart of the example process used for determining optimal market reserve prices for one or more bidded terms in online keyword auctions with advanced match.

FIG. 4 is a diagram showing a flowchart of another example process used for determining a market reserve price of a query and reordering the exact and advanced matched advertisements for output and display.

### DESCRIPTION OF EXAMPLE EMBODIMENT(S)

The following example embodiments and their aspects are described and illustrated in conjunction with apparatuses, methods, and systems which are meant to be illustrative examples, not limiting in scope.

### A. Network Implementation

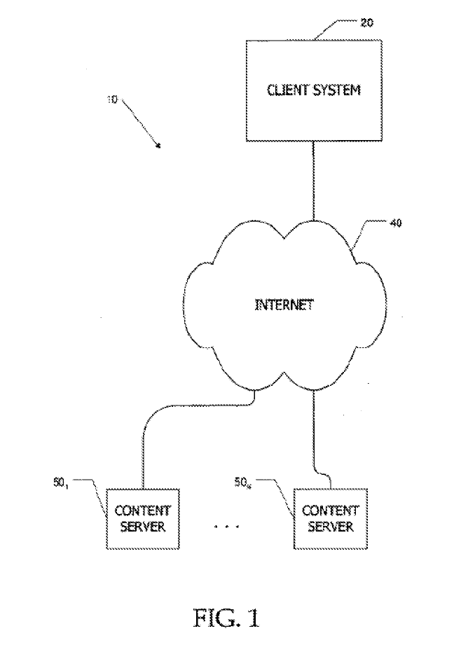

FIG. 1 illustrates a general overview of a communication network 10 including a client system 20 and a number of servers 50₁ to 50_{N} according to one particular embodiment of the present invention. In computer network 10, client system 20 is coupled through the Internet 40, or other communication network, e.g., over any local area network (LAN) or wide area network (WAN) connection, to any number of servers 50₁ to 50_{N}. As will be described herein, client system 20 is configured according to the present invention to communicate with any of servers 50₁ to 50_{N}, e.g., to access, receive, retrieve and/or display web pages, text or graphical advertisements, and other information such as audio or video media content. More particularly, an advertiser may participate in an online keyword auction from a Web browser running on client system 20, which communicates with any of servers 50₁ to 50_{N} to retrieve market reserve prices and accept or decline the advertiser's bids. A user may submit a query to an Internet search engine from a Web browser running on client system 20, which communicates with any of servers 50₁ to 50_{N} to retrieve search results and advertisements.

As FIG. 1 illustrates, particular embodiments may operate in a network environment including a plurality of hosts and other distributed systems. For example, client system 20 could include a desktop personal computer, workstation, laptop, personal digital assistant (PDA), cell phone, or any WAP (Wireless Application Protocol)-enabled device or any other computing device capable of interfacing directly or indirectly to the Internet. Client system 20 typically runs a browsing program, such as Microsoft's Internet Explorer™ browser, Netscape Navigator™ browser, Mozilla Firefox™ browser, Opera™ browser, or a WAP-enabled browser in the case of a cell phone, PDA or other wireless device, or the like, allowing a user of client system 20 to process and view information and web pages available to it from content servers 50₁ to 50_{N} over Internet 40.

Client system 20 also typically includes one or more user interface devices for interacting with a graphical user interface (GUI) provided by the browser on a display (e.g., monitor screen, LCD display, etc.), in conjunction with pages, forms and other information provided by servers 50₁ to 50_{N} or other servers. The present invention is suitable for use with the Internet, which refers to a specific global network of networks. However, it should be understood that other networks can be used instead of or in addition to the Internet, such as an intranet, an extranet, a virtual private network (VPN), a non-TCP/IP based network, any LAN or WAN or the like.

According to one embodiment, client system 20 and all of its components, any of the servers 50₁ to 50_{N} and all of its components, are configurable and made operative using an application including computer code run using a central processing unit such as an Intel x86-compatible microprocessor, an AMD x86-compatible microprocessor, or the like or multiple microprocessors. Computer code for configuring and operating client system 20 to communicate, process and display data and media content as described herein is preferably downloaded and stored on a hard disk, but the entire program code, or portions thereof, may also be stored in any other volatile or non-volatile memory medium or device such as a ROM or RAM, or provided on any media capable of storing program code, such as a compact disk (CD) medium, a digital video disk (DVD) medium, a floppy disk, and the like. Additionally, the entire program code, or portions thereof, may be transmitted and downloaded from a software source, e.g., from one of content servers 50₁ to 50_{N} to client system 20 over the Internet, or transmitted over any other network connection (e.g., extranet, VPN, LAN, or other conventional networks) using any communication medium and protocol (e.g., TCP/IP, HTTP, HTTPS, Ethernet, or other conventional media and protocol).

It should be appreciated that computer code for implementing embodiments of the present invention can be C, C++, HTML, XML, Java, etc., or any suitable scripting language, e.g., VBScript, JavaScript, or any other suitable programming language that can be executed on any of servers 50₁ to 50_{N} or client system 20, or compiled to execute on any of servers 50₁ to 50_{N} or client system 20. In some embodiments, needed code is embedded in a web page and sent to client system 20 and executed, or code already present at servers 50₁ to 50_{N} and client system 20 is executed.

### B. Computing Client or Server Architecture

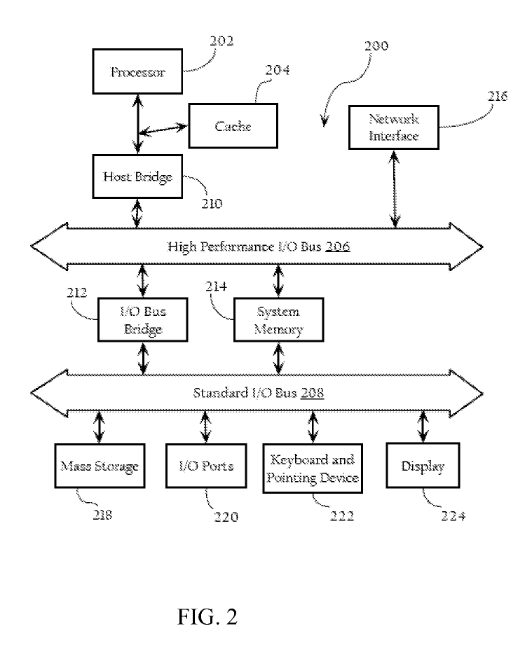

FIG. 2 illustrates, for didactic purposes, a hardware system 200, which may be used to implement a server or a client system. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218 and I/O ports 220 couple to bus 208. In one embodiment, hardware system 200 may also include a keyboard and pointing device 222 and a display 224 coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the RF coverage map generator, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist with the components of hardware system 200 being coupled to the single bus. Furthermore, hardware system 200 may include additional components, such as additional processors, storage devices, I/O devices, or memories.

In one embodiment, the market reserve price optimization process described herein is implemented as a series of software routines run by hardware system 200. These software routines comprise a plurality or series of instructions to be executed by a processor in a hardware system, such as processor 202. Initially, the series of instructions are stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the LINUX operating system. However, the present invention may be used with other suitable operating systems, such as the Windows® 95/98/NT/XP/Vista operating system, available from Microsoft Corporation of Redmond, Wash., the Apple Macintosh Operating System, available from Apple Computer Inc. of Cupertino, Calif., and the like.

### C. Optimization of Market Reserve Prices

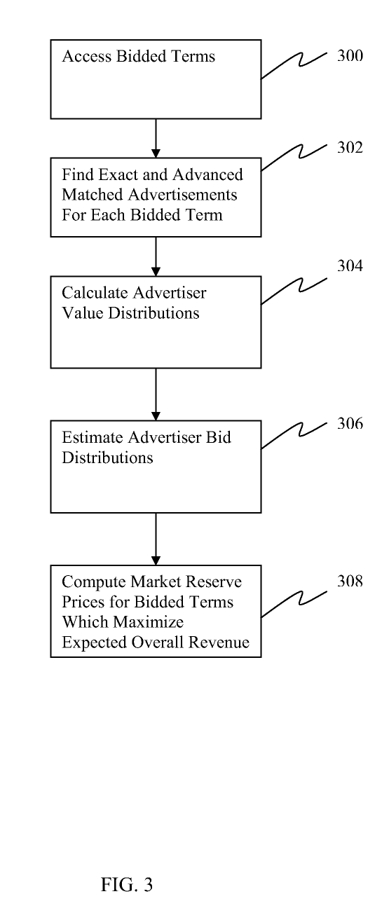

FIG. 3 illustrates an example process used for estimating optimal market reserve prices for one or more bidded terms, which process may be used by an embodiment of the present invention. In the first step 300, the embodiment accesses one or more bidded terms. A bidded term comprises one or more keyword on which at least one advertiser made a bid for an advertisement. In some embodiments, the bidded terms are retrieved from historical bids stored on memory devices. In other embodiments, one or more bidded terms are received in real time from advertisers participating in online keyword auctions.

More than one advertiser may bid on the same term. As a result, a marketplace is created since the advertisers may compete for a bidded term if the term is valuable to the advertisers. Therefore, each term is considered a marketplace. For example, an advertiser may bid on a term “tennis racquet” for an advertisement of a Wilson™ tennis racquet, while another advertiser may bid on the same term for a Prince™ tennis racquet. When a user enters “tennis racquet” as a query and submits the query to an Internet search engine, the advertisements for the Wilson™ and the Prince™ tennis racquet may be displayed along with the search results of the query. Consequently, an auctioneer, which typically is an Internet search engine, may set a market reserve price for the term “tennis racquet” to maximize expected revenue.

In step 302, the embodiment finds exact and advanced matched advertisements for each bidded term. Exact matched advertisements of a bidded term comprise advertisements for which one or more advertisers bidded on the term. For example, for a bidded term “tennis racquet”, the advertisements that are bidded exactly on “tennis racquet” by one or more advertisers are the exact matched advertisements.

Advanced matched advertisements of a bidded term comprise advertisements for which one or more advertisers bidded on one or more terms that are different from the bidded term. In some embodiments, the bidded terms of the advanced matched advertisements comprise related terms that receive traffic from the bidded term and related terms that produce traffic for the bidded term.

For each bidded term, if there is at least one impression of an advertisement that was bidded for a different but related term, the related term is considered to have received traffic from the bidded term. On the other hand, the related term is considered to have produced traffic for the bidded term.

An impression of an advertisement is the display of the advertisement to a user when the user submits a query to an Internet search engine and receives search results along with one or more advertisements. In some embodiments, a matching engine is used to match a query submitted by an Internet search engine user to one or more advertisements. There may be exact and advanced matched advertisements for the query. For an exact matched advertisement, the whole query must exactly match the bidded term of the advertisement. For an advanced matched advertisement, the query is different from the bidded term of the advertisement but may be related to the bidded term. For example, for a query “tennis racquet”, an advertisement which was bidded on “tennis racquet” is an exact matched advertisement, while an advertisement bidded on “Wilson racquet” may be an advanced matched advertisement. When a user submits the query “tennis racquet” to an Internet search engine, the advertisement bidded on “tennis racquet” and the advertisement bidded on “Wilson racquet” may be displayed along with the search results, which may result an impression for each advertisement. In some other embodiments, an impression of an advertisement may be the interaction of the advertisement by an Internet search engine user. For example, the user may click on an advertisement, call a phone number listed on the advertisement, enter a promotion code on another Web site as instructed by the advertisement, etc.

In step 304, the embodiment calculates an advertiser value distribution from historical bids on the bidded terms of the exact and advanced matched advertisements. In some embodiments, if there is no historical bid information on a bidded term, a default reserve price, such as $0.10, is used as the only bid on the bidded term. An advertiser value distribution comprises a probability distribution for a plurality of values of a click for a plurality of advertisers who bid on the one or more bidded terms. An advertiser privately values a bidded term based on the return of the advertisement that is bidded on the term. The return of the advertisement may be tangible effects such as increased revenue of the advertised product or services resulting from clicks on the advertisements, but may also be intangible effects such as increased brand awareness. The advertiser may raise the bid up to the private value of the advertisement to the advertiser. An auctioneer may attempt to infer the advertiser value distribution and set the market reserve prices based on the inferred private advertiser values of the bidded terms. With advanced match, however, there may be two types of advertisers for each bidded term. Some advertisers may have bidded on the exact same term as the bidded term, while others may not have bidded on the same term, yet their advertisements are displayed for the bidded term through advanced match.

The value distribution F_{q} of advertisers who bid on a term q may be determined using a number of techniques known to those skilled in the art, such as by computing the probability distribution using historical bidding data, or by further adjusting the bidding data using a clickability score. The clickability of an advertisement is a quality score for the advertisement. It measures the likelihood that an advertisement of a bidded term may be clicked by a user relative to other advertisements of other bidded terms.

The value distribution G_{q} of advertiser who do not directly bid on q but whose advertisement are displayed for q through advanced match may be determined by advertisers bidding on queries in T_{q} from the following:

$${G}_{q} ∝ {\sum }_{{q}^{t} ∈ {T}_{q}} {n}_{{q}^{t} , q} {F}_{{q}^{t}} ,$$

where T_{q} is the set of q^{t} that produce traffic for q, and n_{q}_{^{t}}_{,q} is the number of advertisers who bid on q^{t} but whose advertisements are advanced matched to q.

In step 306, the embodiment estimates an advertiser bid distribution of the bidded terms. An advertiser bid distribution comprises a probability distribution for a plurality of bids from a plurality of advertisers who bid on the one or more bidded terms. For each bidded term q, there may be one set of terms T_{q} that produce traffic for q and another set of terms S_{q} that receive traffic from q, a marketplace q comprises all the terms that contribute traffic to q as the following: T_{q}→q→S_{q}.

Each advertiser may be treated as a fractional bidder for each marketplace. For example, an advertiser bids on a term “tennis racquet” for a Wilson™ tennis racquet advertisement. When a user submits a query “wilson racquet” to an Internet search engine, the Wilson™ racquet advertisement may be returned and displayed through advanced match even though the advertiser does not directly bid on the term “wilson racquet”. Therefore, the advertiser may be treated as a fractional bidder for the marketplace of “wilson racquet”.

For another example, consider an advertiser who participates in two marketplaces q and q′. The bid distribution of an isolated marketplace q is π(b; p_{q}, G_{q}, N_{q}), where S_{q}=q=T_{q} and b is the vector of bids from all advertisers, p_{q} is the market reserve price of q, G_{q} is the value distribution of advertisers whose advertisements are displayed for q, and N_{q} is the number of advertisers whose advertisements are displayed for q. If weight ω is the percentage of traffic an advertiser receives from q when the advertiser participates in the marketplace q, the advertiser is considered to be participating in marketplace q with weight ω and in marketplace q′ with weight 1−ω. When participating in q, the advertiser's bid follows distribution ωπ(b;p_{q},G_{q},N_{q}). If f_{q,q′} is the fraction of traffic that a typical advertiser bidding on q receives from being shown for q′, and c_{q,q′}, q′∈S_{q} is the click volume from q′ for a typical advertiser who bids on q, then

$${f}_{q , {q}^{′}} = \frac{{c}_{q , {q}^{′}}}{{\sum }_{{q}^{″} ∈ {S}_{q}} {c}_{q , {q}^{″}}} .$$

If ω=f_{q,q′}, the bid distribution at q becomes H_{q}=f_{q,q′}π(b;p_{q},G_{q},N_{q})+f_{q,q′}π(b;max(p_{q},p_{p′}),G_{q′},N_{q′}) with G_{q}=F_{q} and G_{q′}=(n_{q,q′}F_{q}+n_{q′}F_{q′})/(n_{q,q′}+n_{q}), where F_{q} is the value distribution of advertisers who bid on q and n_{q,q′} is the number of advertisers for q whose advertisements are advanced matched to q′. On the other hand, the bid distribution at q′ is proportional to n_{q,q′}H_{q}+n_{q′}π(b;q_{q′},G_{q′},N_{q′}), where n_{q,q′} is the number of advertisers who bid on q but whose advertisements are advanced matched to q′.

Generalizing the above example wherein an advertiser may participate in all marketplaces simultaneously, the bid distribution at q by all advertisers who bid on q is

$${H}_{q} = {\sum }_{{q}^{′} ∈ {S}_{q}} {f}_{q , {q}^{′}} π ( b ; max ( {p}_{q} , {p}_{{q}^{′}} ) , {G}_{{q}^{′}} , {N}_{{q}^{′}} ) ,$$

where max(p_{q},p_{q′}) is the maximum of the market reserve prices p_{q} and p_{q′}.

With advanced match, an advertiser's advertisement may be displayed for q through advanced match even though the advertiser does not bid on q. Therefore, distribution of N_{q} bids that appear at q overall is

$${B}_{q} = {\sum }_{{q}^{t} ∈ {T}_{q}} {n}_{{q}^{t} , q} {H}_{{q}^{t}} / {N}_{q} .$$

In some embodiments, a bid placed for an advertisement for marketplace q but is displayed for q′ is adjusted to reflect the difference in clickability of advertisement bidded for q and q′. When an advertiser for q submits a bid b_{q′} for q′, it appears as bid

$${b}_{{q}^{′}} \frac{{clkb}_{q}}{{clkb}_{{q}^{′}}} for q ,$$

where clkb_{q} is the clickability of the advertisement for q. Therefore,

$${H}_{q} = {\sum }_{{q}^{′} ∈ {S}_{q}} {f}_{q , {q}^{′}} {d}_{q , {q}^{′}} π ( b ; max ( {p}_{q} , {p}_{{q}^{′}} ) , {G}_{{q}^{′}} , {N}_{{q}^{′}} )$$

$$and$$

$${B}_{q} = {\sum }_{{q}^{t} ∈ {T}_{q}} {n}_{{q}^{t} , q} {d}_{q , {q}^{′}} {H}_{{q}^{t}} / {N}_{q} ,$$

where

$${d}_{q , {q}^{′}} = \frac{{clkb}_{q}}{{clkb}_{{q}^{′}}} .$$

In step 308, the embodiment computes optimal market reserve prices for the bidded terms to maximize expected revenue for an Internet search engine. Revenue per bidded term r_{q}(p) with reserve price p may be determined from the bid distribution B_{q} estimated in step 306. The overall revenue

$${\sum }_{q} {λ}_{q} {r}_{q} ( p )$$

is dependent on the popularity λ_{q} of each bidded term q and may be optimized using techniques known to those skilled in the art, such as simulated annealing or neural networks. In some embodiments, the computed optimal market reserve prices may be stored in memory devices along with the bidded terms. In other embodiments, the computed optimal market reserve prices for the bidded term may be outputted for display to the advertisers who are bidding in real time on the terms in an online keyword auction.

In some other embodiments, the revenue estimates r_{q}(p) may be updated from observational real time click data via on online update and the updated revenue estimate Δr_{q}(p) a is the following:

$$Δ {r}_{q} ( p ) = α \frac{1}{n} K ( \frac{p - {p}_{obs}}{n} ) ( {r}_{obs} - {r}_{q} ( {p}_{obs} ) ) ,$$

where K is a kernel function that integrates to one and α is a learning rate, p_{obs} is the observed reserve prices, r_{obs} is the observed revenue, and n is the number of participating advertisers.

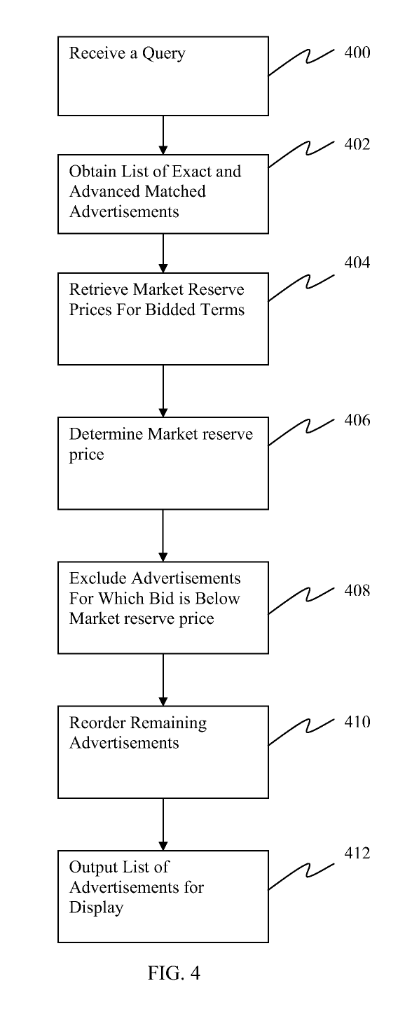

FIG. 4 illustrates an example process used to determine a market reserve price for a query and to output a list of advertisements for display, which process may be used by an embodiment of the present invention. In the first step 400, the embodiment receives a query wherein a query comprises one or more keywords. In one embodiment, the query may be in the original form when the user entered it in a search box of an Internet search engine. In other embodiments, the query may have been processed by a query processing engine which may correct misspellings in the query, remove stop words such as “the”, “of”, and “a” from the query, or reorder the keywords in the query.

In step 402, the embodiment finds a list of exact matched and advanced advertisements for the query. An advertiser typically bids on one or more terms for an advertisement. Each bidded term comprises one or more keywords. Since more than one advertiser may bid on a term, each bidded term is a marketplace. For exact matched advertisements, the whole query must exactly match a bidded term on which at least one advertiser bidded. For example, if the query is “tennis racquet”, then exact matched advertisements comprises advertisements for which one or more advertisers bidded on the term “tennis racquet”. Advanced matched advertisement for a query comprise advertisements for which one or more advertisers bidded on one or more terms that are different from the query. For example, advertisers may have bidded on the term “Wilson racquet” for an advertisement of a Wilson™ tennis racquet. Although “Wilson racquet” does not exactly match the query “tennis racquet”, the advertisement of the Wilson™ tennis racquet may be displayed along with the query results through advanced match. In some embodiments, the bidded terms of advanced matched advertisements may not match any keywords in the query. For example, when the query is “John McEnroe”, the Wilson™ tennis racquet advertisements may be displayed through advanced match.

In step 404, the embodiment retrieves the reserve prices of each bidded term of the exact and advanced matched advertisements. An auctioneer, which typically is an Internet search engine, may set a market reserve price for each bidded term with the goal of maximizing overall revenue from all of the bidded terms. For example, the market reserve price for the bidded term “tennis racquet” may be set at $0.10. Each exact and advanced matched advertisement comprises one or more bidded terms from one or more advertisers. In one embodiment, the auctioneer may set a constant market reserve price for any bidded term. For example, an Internet search engine may set a market reserve price of $0.10 for any term an advertiser may bid on. In other embodiments, an Internet search engine may set a constant market reserve price for subsets of the bidded terms, while the rest of the bidded term may have different market reserve prices. In some other embodiments, an Internet search engine may set a different market reserve price for each bidded term.

In step 406, the embodiment determines a market reserve price for the query based on the retrieved market reserve prices for the bidded terms of the exact and advanced matched advertisements. In some embodiments, the query itself may be a bidded term and therefore may have a market reserve price. For example, if the query is “tennis racquet” which happens to be a bidded term with a market reserve price of $0.10, the query is considered to have a market reserve price of $0.10. In another embodiment, if the query itself is a bidded term with a market reserve price, the minimum reserve price for the query is set at the same price regardless of the market reserve prices of any other bidded terms. In other embodiments, the embodiment may determine the market reserve price for the query by considering the market reserve prices of all the bidded terms of the exact and advanced matched advertisements. For example, the embodiment may set the maximum of the market reserve prices of all the bidded terms as the market reserve price of the query. Similarly, the embodiment may set the minimum or average of the market reserve prices of all the bidded terms as the market reserve price of the query.

In step 408, the embodiment excludes exact and advanced advertisements for which the bid is below the market reserve price determined in step 406. The excluded advertisements may not be considered for reordering purposes in the next step. In one embodiment, the bid for an advertisement is the pecuniary value of the bid on the bidded term for the advertisement. In other embodiments, the bid is the product of the pecuniary value of the bid and the clickability of the advertisement. In some embodiments, a click may be an actual mouse click on the advertisement. In some other embodiments, a click may be an interaction event with the advertisement. For example, the advertisement may display a phone number, and a user may call the phone number after seeing the advertisement. The embodiment may consider calling the specific phone number listed on the advertisement as a click on the advertisement.

In step 408, the remaining advertisements in the list of exact and advanced matched advertisements are reordered. The reordering may be completed using a number of techniques known to those skilled in the art, such as by using a sequential order of the bids. In some embodiments, a reordering engine may use various algorithms to reorder the list of advertisements. The reordering may be based on the popularity and relevance of the advertisements, the expected number of clicks, the expected revenue, or a combination of various factors.

In the final step 410, the embodiment outputs the reordered list of advertisement for display. In some embodiments, all of the advertisements may be displayed along with the search results of the query. In other embodiments, the first few advertisements may be displayed based on the available space on the search results page. The exact location of the advertisements may be determined by an Internet search engine. In some other embodiments, the first few advertisements may be displayed right above the first search result, while the next few advertisements may be displayed on the right hand side of the search results.

The present invention has been explained with reference to specific embodiments. For example, while embodiments of the present invention have been described with reference to specific hardware and software components, those skilled in the art will appreciate that different combinations of hardware and/or software components may also be used, and that particular operations described as being implemented in hardware might also be implemented in software or vice versa. Other embodiments will be evident to those of ordinary skill in the art. For example, a large parallel and distributed computing platform may be used for the estimating and modeling of market reserve prices. It is therefore not intended that the present invention be limited, except as indicated by the appended claims.

What is claimed is:

1. A method comprising:
accessing one or more bidded terms each having one or more keywords;
finding a list of exact and advanced matched advertisements for each bidded term;
retrieving one or more bids for the exact and advanced match advertisements from one or more advertisers;
inferring an advertiser value distribution for each bidded term;
estimating an advertiser bid distribution for each bidded term wherein each bidded term is given a market reserve price in an online auction;
computing a market reserve price for each bidded term based on the advertiser bid distributions.

2. The method of claim 1, wherein the online auction is a generalized second price auction.

3. The method of claim 1, wherein exact matched advertisements for a bidded term comprise advertisements for which one or more advertisers bidded on the bidded term in an online auction.

4. The method of claim 1, wherein advanced matched advertisements for a bidded term comprise advertisements for which one or more advertisers bidded on one or more terms that are different from the bidded term, wherein the one or more terms comprises one or more keywords that receive traffic from the bidded term and one or more keywords that produce traffic for the bidded term.

5. The method of claim 4, wherein a term that receives traffic from the bidded term comprises one or more keywords whereby there is at least one impression of an advertisement that was bidded for the bidded term when the term is queried.

6. The method of claim 4, wherein a term that produces traffic for the bidded term comprises one or more keywords whereby there is at least one impression of an advertisement that was bidded for the term when the bidded term is queried.

7. The method of claim 5, wherein an impression of an advertisement is the display of the advertisement on a Web page.

8. The method of claim 5, wherein an impression of an advertisement is the display and interaction of the advertisement on a Web page.

9. The method of claim 1, wherein the estimating step comprises determining weights for the bidded terms for aggregating bid distributions of the exact and advanced matched advertisements.

10. The method of claim 9, wherein a bid of a bidded term is the pecuniary value bidded by an advertiser for the bidded term multiplied by a clickability score of the bidded term.

11. The method of claim 9, wherein the weights of the bidded terms are derived from real time click traffic, wherein click traffic comprises a plurality of clicks on the one or more exact and advanced matched advertisements.

12. The method of claim 9, wherein the weights of the bidded terms are derived from historic click traffic.

13. The method of claim 1, wherein an advertiser value distribution comprises a probability distribution for a plurality of values of a click for a plurality of advertisers who bid on the one or more bidded terms.

14. The method of claim 1, wherein an advertiser bid distribution comprises a probability distribution for a plurality of bids from a plurality of advertisers who bid on the one or more bidded terms.

15. The method of claim 1, wherein the computing step comprises:
changing market reserve prices for the bidded terms and the one or more terms bidded by the advertisers for the exact and advanced matched advertisements;
excluding bids for a term which are below the market reserve price of the term;
estimating an advertiser bid distribution for each bidded term given the changed market reserve price for each bidded term;
deriving an expected revenue for each bidded term;
determining market reserve prices for the bidded terms which maximize an overall expected revenue, wherein the overall expected revenue comprises the summation of the product of the derived revenue of each bidded term and a popularity score of the bidded term.

16. The method of claim 15, wherein the optimal market reserve prices are determined for any user defined subset of the bidded terms, whereby the reserve prices are fixed for the rest of the bidded terms.

17. The method of claim 1, wherein the computing step comprises a simulated annealing optimization process.

18. An apparatus, comprising:
a memory;
one or more processors;
logic encoded in one or more computer readable medium, wherein the logic when executed is operable to use the one or more processors to:
access one or more bidded terms each having one or more keywords;
find a list of exact and advanced matched advertisements for each bidded term;
retrieve one or more bids for the advertisements from one or more advertisers;
infer an advertiser value distribution for each bidded term;
estimate an advertiser bid distribution for each bidded term wherein each bidded term is given a market reserve price in an online auction;
compute an optimal market reserve price for each bidded term.

19. A method comprising:
receiving a query having one or more keywords;
finding a list of exact and advanced matched advertisements for the query;
retrieving market reserve prices for the query and the one or more bidded terms of the exact and advanced matched advertisements;
determining a market reserve price;
excluding one or more advertisements wherein the bid is lower than the market reserve price;
ordering the remaining advertisements in the list of exact and advanced matched advertisements;
outputting the list of advertisements for display.

20. The method of claim 20, wherein the determining step comprises selecting the market reserve price of the query.

21. The method of claim 20, wherein the determining step comprises selecting the market reserve price of a bidded term of the exact and advanced matched advertisements.

22. The method of claim 20, wherein the determining step comprises selecting the market reserve price of the maximum of the reserve prices of the query and the bidded terms of the exact and advanced matched advertisements.

23. An apparatus, comprising:
a memory;
one or more processors;
logic encoded in one or more computer readable medium, wherein the logic when executed is operable to use the one or more processors to:
receive a query having one or more keywords;
find a list of exact and advanced matched advertisements for the query;
retrieve market reserve prices for the query and the one or more bidded terms of the exact and advanced matched advertisements;
determine a market reserve price;
exclude one or more advertisements wherein the bid is lower than the market reserve price;
order the remaining advertisements in the list of exact and advanced matched advertisements;
output the list of advertisements for display.
